(19) United States
(12) Patent Application Publication
(10) Pub. No.: US 2023/0145146 A1
(43) Pub. Date: May 11, 2023

(54) POLYMER COLOR ANALYSIS BY TRANSMISSION SPECTROPHOTOMETRY USING HIGH REFRACTIVE INDEX COMPOSITE LIQUIDS

(71) Applicants: North Carolina State University, Raleigh, NC (US); Eastman Chemical Company, Kingsport, TN (US)

(72) Inventors: Orlin D. Velev, Cary, NC (US); Lokendra Pal, Cary, NC (US); Sachin Agate, Raleigh, NC (US); Austin Williams, San Francisco, CA (US); Joseph Dougherty, Kingsport, TN (US)

(21) Appl. No.: 17/980,807

(22) Filed: Nov. 4, 2022

Related U.S. Application Data
(60) Provisional application No. 63/277,269, filed on Nov. 9, 2021.

(51) Int. Cl. G01N 21/31

(52) U.S. Cl. CPC G01N 21/31

(57) ABSTRACT

The present invention provides a method for directly measuring the color of transparent polymer particles. A composite liquid, comprising a transparent liquid with nanoparticles and matching the refractive index of the polymer, can be used to mitigate the light scattering due to the roughness of the particles surface. The method can be applied to copolyester particles, such as copolyester pellets.

### CROSS REFERENCE

This application claims priority to U.S. Provisional Application Ser. No. 63/277,269, filed on Nov. 9, 2021, which is incorporated herein by reference in its entirety.

### TECHNICAL FIELD

The present invention relates generally to the color measurement of polymers. More specifically, the present invention relates to the direct measurement of color of polymer particles, such as copolyester particles.

### BACKGROUND

Various polymers, and particularly copolyesters, are utilized in a wide range of products where their optical properties, such as color, are paramount to their applications. Typically, a sample of polymer particles, which often are in the form of pellets, is molded into a plaque and the color is measured by spectroscopic techniques. The need to produce a molded plaque for color analysis comes from the fact that direct analysis of the color of polymer pellets by spectroscopic techniques do not correspond with that of injection molded parts from those same polymer pellets. Surface scattering effects of the pellets make the use of direct spectroscopic techniques infeasible.

Copolyesters are a wide class of polymer materials characterized by an ester linkage in the backbone of the polymer formed by reactions between diols and diacids. The versatility with which copolyesters can be produced and their high clarity and toughness enable a wide range of applications for these materials in medical products, packaging, and consumer goods, where the optical properties of the copolyesters are paramount towards their utilization. Transmission and reflection spectrophotometry are the most common techniques of color measurement, with thermoplastic copolyesters typically injection-molded into plaques prior to their analysis.

To quantify the color of these polymer plaques, the spectra obtained by spectrophotometry are transformed into CIELAB color space, where the illumination conditions and the angle of incidence are accounted for and used to convert the resulting spectra to quantified color values in the three-dimensional L*, a* and b* color values. In the CIELAB color space, the L* values indicate the lightness of the sample on a scale of 0-100, with L*=0 indicating black and L*=100 indicating diffuse white. The a* value indicates the red-green spectrum (a* scale of −128 to 127, with negative values indicating green and positive values indicating red), and b* indicates the color on the yellow-blue spectrum (b* scale of −128 to 127, with positive b* indicating yellow and negative b* values indicating blue). To measure the color distance in this three-dimensional color space, ΔE is used to quantify the Euclidean distance between the color values of samples. ΔE≥2 indicates a “just noticeable difference” in human perception.

Manufacturing copolyesters typically results in copolyester pellets that are of non-uniform size and typically around 1-2 mm in diameter. Such pellets are difficult to measure using the standard transmission and reflection spectrophotometry technique due to their highly rough surfaces and the resulting light scattering effects. For this reason, it is difficult to predict what the color of a molded plaque will be from pellets, necessitating the time-intensive molding of copolyester pellets into plaques to get improved quantification of the color of the copolyester.

Refractive index matching is a technique used in microscopy to improve visualization as well as a method to minimize van der Waals interactions in colloidal systems. High refractive index (RI) copolyesters are difficult to refractive index match because few liquids have high refractive index while not interacting with the polymer particles and disrupting color measurements.

There is a need for a method to directly measure color of polymer pellets without the time consuming and expensive step of making a molded plaque. There is a need for a rapid color test that can show anomalies between batches of polymer production. There is also a need for a rapid color test of polymer particles in other forms, such as granules, powders, and recycle scrap pieces.

### SUMMARY

In one exemplary embodiment, the present disclosure provides a process for directly measuring the color of polymer particles. The process comprises a) obtaining polymer particles; b) obtaining a composite fluid comprising a transparent liquid and nanoparticles; c) preparing a sample by combining a first fraction of the polymer particles with the composite fluid; and d) performing transmission spectrophotometry to determine a color of the sample. The polymer particles are transparent, and the transparent liquid is inert to the polymer particles. An absolute difference between the refractive index of the polymer particles and the refractive index of the composite fluid (ΔRI) is less than 0.02.

In another embodiment, the present disclosure provides a process for directly measuring the color of copolyester particles. The process comprises a) obtaining copolyester particles; b) obtaining a composite fluid comprising a transparent liquid and nanoparticles; c) preparing a sample by combining a first fraction of the copolyester particles with the composite fluid; and d) performing transmission spectrophotometry to determine a color of the sample. The transparent liquid is inert to the copolyester particles, and the nanoparticles comprise zirconia and/or titania. An absolute difference between the refractive index of the copolyester particles and the refractive index of the composite fluid (ΔRI) is less than 0.02.

### BRIEF DESCRIPTION OF THE DRAWINGS

The present disclosure is illustrated and described herein with reference to the various drawings, in which like reference numbers are used to denote like system components/method steps, as appropriate, and in which:

FIGS. 1(a) and 1(b) are graphs of the transmission spectroscopy of (a) copolyester plaques and (b) pellets;

FIG. 2 is a graph of the calculated ΔE values for X1-X4 pellets in high refractive index PEG400-ZrO₂ composite liquids with their respective plaques used as the reference color values for each sample;

FIG. 3 is a graph of the calculated ΔE values for the different X1 pellet batches in high refractive index PEG400-ZrO₂ composite liquids with the respective X1 plaque used as the reference color value for each sample.

### DETAILED DESCRIPTION

In one exemplary embodiment, the present disclosure provides a process for directly measuring the color of polymer particles. The process comprises a) obtaining polymer particles; b) obtaining a composite fluid comprising a transparent liquid and nanoparticles; c) preparing a sample by combining a first fraction of the polymer particles with the composite fluid; and d) performing transmission spectrophotometry to determine a color of the sample. The polymer particles are transparent, and the transparent liquid is inert to the polymer particles. An absolute difference between the refractive index of the polymer particles and the refractive index of the composite fluid (ΔRI) is less than 0.02

The present invention may be understood more readily by reference to the following detailed description of the invention taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

As used herein, the term “and/or”, when used in a list of two or more items, means that any one of the listed items can be employed by itself, or any combination of two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the term “transparent liquid”, refers to a liquid through which at least 50% of visible light passes when a sample of the transparent liquid is subject to transmission spectrophotometry.

As used herein, the term “polymer particles are transparent”, refers to the polymer material itself, without surface scattering issues. For example, a plaque made from the polymer particles is transparent, or the molten polymer of the polymer particles is transparent, in that at least 50% of visible light passes through a sample subject to transmission spectrophotometry.

As used herein the term “polymer particles” and “copolyester particles”, refer to the form of the polymer and copolyester, respectively, for which color is to be determined. In a common example, the particles are pellets from a manufacturing process. Additional non-limiting examples of particles include powders, granules, and recycled scrap pieces.

As used herein, the term “inert”, refers to having no chemical or physical impact on the particles. When a transparent liquid is inert to the polymer particles, or the copolyester particles, the transparent liquid does not react with the polymer or the copolyester causing, for example, dissolution of the particles or changes in color. Also, the liquid does not cause physical changes to the particles, such as causing the particles to swell.

As used herein, the term “volatile liquid” refers to a liquid that is readily separated from the transparent liquid using heat.

As used herein, the term “the refractive index of the polymer particles” and “the refractive index of the copolyester particles” refers to the refractive index of the polymer or the copolyester as effectively measured. As the refractive index is a material property, and particles are difficult to characterize directly due to surface scattering effects, the refractive indices of the polymer particles and copolyester particles may be measured on a plaque made from the polymer particles or the copolyester particles, respectively.

The process for directly measuring color of polymer particles comprises obtaining polymer particles and a composite fluid, wherein an absolute difference between the refractive index of the polymer particles and the refractive index of the composite fluid (ΔRI) is less than 0.02. In some aspects the absolute difference between the refractive index of the polymer particles and the refractive index of the composite fluid (ΔRI) is less than 0.015 or less than 0.01, or less than 0.005.

A quality check for the process is that the color of the sample closely resembles the color of a plaque made from the polymer particles. In some aspects, the color of the sample is measured using the CIELAB L*, a*, and b* values. In some aspects, color is also measured on a plaque made from a second fraction of the polymer particles. In some aspects, the Euclidean distance (ΔE) in the CIELAB color space between the sample and the plaque made from a second fraction of the polymer particles is less than 20, or less than 15, or less than 10.

The process for directly measuring color of polymer particles comprises (a) obtaining polymer particles, wherein the polymer particles are transparent. Obtaining polymer particles is not particularly limiting. Non-limiting examples include polymer pellets sampled during a polymer manufacturing process and polymer pellets tested prior to making an article. As the process is used to perform transmission spectrophotometry to determine color of the sample, the polymer particles are transparent.

Many polymers of industrial importance are transparent. Non-limiting examples include acrylic (polymethylmethacrylate), polyester, copolyester, polycarbonate, polystyrene, butyrate (cellulose acetate butyrate), cylco olefin polymers, poly-l-lactic-acid (PLLA), polyurethane, polyurea, and/or polyethersulfone (PES). In some aspects, the polymer particles comprise acrylic (polymethylmethacrylate), polyester, copolyester, polycarbonate, polystyrene, butyrate (cellulose acetate butyrate), cylco olefin polymers, poly-l-lactic-acid (PLLA), polyurethane, polyurea, and/or polyethersulfone (PES). In some aspects, the polymer particles are selected from the group consisting of acrylic (polymethylmethacrylate), polyester, copolyester, polycarbonate, polystyrene, butyrate (cellulose acetate butyrate), cylco olefin polymers, poly-l-lactic-acid (PLLA), polyurethane, polyurea, and/or polyethersulfone (PES).

The process for directly measuring color of polymer particles comprises b) obtaining a composite fluid comprising a transparent liquid and nanoparticles. In some aspects, the transparent liquid comprises dimethylaminoethanol, ethylene glycol, ethanolamine, polyethylene glycol, glycerol, silicone oil, and/or polymethylphenyl-siloxane. In some aspects the transparent liquid comprises polyethylene glycol, glycerol, silicone oil, and/or polymethylphenyl-siloxane. In some aspects the transparent liquid comprises polyethylene glycol, and the polyethylene glycol has a molecular weight ranging from 50 to 1000, or from 100 to 800, or from 200 to 600.

In some aspects, the nanoparticles comprise zirconia and/or titania. In some aspects, the nanoparticles comprise zirconia. In some aspects, the nanoparticles consist essentially of zirconia. The size of the nanoparticles is not particularly limiting so long as the composite fluid remains transparent, and the nanoparticles are not large enough to significantly scatter visible light during the transmission spectrophotometry measurement. In some aspects the nanoparticles have an average diameter less than 10 nm, less than 15 nm, less than 20 nm, less than 30 nm, less than 50 nm, less than 75 nm, less than 100 nm, or less than 150 nm.

In some aspects, step b), obtaining the composite liquid comprises i) obtaining the transparent liquid; ii) obtaining the nanoparticles, wherein the nanoparticles are dispersed in a first volatile liquid; iii) mixing the transparent liquid and the nanoparticles to form a mixture; and applying heat to the mixture to remove the first volatile liquid and form the composite liquid.

The process for directly measuring color of polymer particles comprises c) preparing a sample by combining a first fraction of the polymer particles with the composite fluid. In some aspects, step c), the preparing of the sample comprises i) adding polymer particles to the spectrophotometry instrument sample-holder; ii) adding the composite liquid to the sample-holder after step i); and iii) placing the sample-holder in an oven for a period of time. The oven temperature and period of time are not particularly limited and are only needed to remove any unwanted volatile liquids and air bubbles from the sample. In some aspects, the oven temperature ranges from 40° C. to 80° C. In some aspects, the period of time ranges from 30 minutes to 48 hours, or from 30 minutes to 24 hours, or from 30 minutes to 12 hours.

In some aspects, for example, if the composite liquid has a high concentration of nanoparticles, the step c) preparing a sample further comprises, iv) before step ii), adding a second volatile liquid to the composite liquid. In some aspects, the second volatile liquid has a normal boiling point at least 5° C. lower, or at least 10° C. lower, or at least 15° C. lower than a normal boiling point of the first volatile liquid. This dissolution step can ensure that the composite liquid gets well distributed among the particles while being removed from the sample before measurements are made, thus not impacting the refractive index of the composite liquid in the sample as tested.

The form of the polymer particles is not particularly limited. In some aspects the polymer particles are selected from the group consisting of pellets, powders, granules, and recycled scrap pieces.

The process for directly measuring color of polymer particles comprises d) performing transmission spectrophotometry to determine a color of the sample. Performing transmission spectrophotometry on a sample to determine its color is well known to one skilled in the art of color measurement.

In another embodiment, the present disclosure provides a process for directly measuring the color of copolyester particles. The process comprises a) obtaining copolyester particles; b) obtaining a composite fluid comprising a transparent liquid and nanoparticles; c) preparing a sample by combining a first fraction of the copolyester particles with the composite fluid; and d) performing transmission spectrophotometry to determine a color of the sample. The transparent liquid is inert to the copolyester particles, and the nanoparticles comprise zirconia and/or titania. An absolute difference between the refractive index of the copolyester particles and the refractive index of the composite fluid (ΔRI) is less than 0.02.

The absolute difference between the refractive index of the copolyester particles and the refractive index of the composite fluid (ΔRI) is less than 0.02. In some aspects the absolute difference between the refractive index of the copolyester particles and the refractive index of the composite fluid (ΔRI) is less than 0.015, or less than 0.01, or less than 0.005.

A quality check for the process is that the color of the samples closely resembles the color of a plaque made from the copolyester particles. In some aspects, the color of the sample is measured using the CIELAB L*, a*, and b* values. In some aspects, color is also measured on a plaque made from a second fraction of the copolyester particles. In some aspects, the Euclidean distance (ΔE) in the CIELAB color space between the sample and the plaque made from a second fraction of the copolyester particles is less than 20, or less than 15, or less than 10

The process for directly measuring color of copolyester particles comprises (a) obtaining copolyester particles. Obtaining copolyester particles is not particularly limiting. Non-limiting examples include copolyester pellets sampled during a copolyester manufacturing process and copolyester pellets tested prior to making an article.

The copolyester particles comprise units of an acid component and units of a glycol component. The copolyester includes 100 mole % of the acid component and 100 mole % of the glycol component. The units of the acid component comprise units derived from terephthalic acid. In some aspects, the units of the acid component also comprise units derived from isophthalic acid, 1,3-cyclohexanedicarboxylic acid, 1,4-cyclohexanedicarboxylic acid, a naphthalenedicarboxylic acid, stilbenedicarboxylic acid, sebacic acid, dimethylmalonic acid, and/or succinic acid. In some aspects the units of the glycol component comprise units derived from ethylene glycol, cyclohexanedimethanol, 1,2-propanediol, 1,3-propanediol, neopentyl glycol, 1,4-butanediol, 1,5-pentanediol, 1,6-hexanediol, p-xylene glycol, polyethylene glycols, polytetramethylene glycols, and/or 2,2,4,4-tetramethyl-1,3-cyclobutanediol. In some aspects, the naphthalenedicarboxylic acid can include 1,4-naphthalenedicarboxylic acid, 1,5-naphthalenedicarboxylic acid, 2,6-naphthalenedicarboxylic acid, and/or 2,7-naphthalenedicarboxylic acid.

In some aspects, units of the acid component comprise units derived from terephthalic acid, and comprise units derived from isophthalic acid, 1,3-cyclohexanedicarboxylic acid, and/or 1,4-cyclohexanedicarboxylic acid; and the units of the glycol component comprise units derived from ethylene glycol, cyclohexanedimethanol, neopentyl glycol, 1,4-butanediol, 1,5-pentanediol, 1,6-hexanediol, and/or 2,2,4,4-tetramethyl-1,3-cyclobutanediol.

In some aspects, the acid component further comprises 0.1 mole % to 1.5 mole % of a branching agent selected from the group consisting of trimellitic anhydride, trimellitic acid, pyromellitic dianhydride, trimesic acid, hemimellitic acid, glycerol, trimethylolpropane, pentaerythritol, 1,2,4-butanetriol, 1,2,6-hexanetriol, sorbitol, 1,1,4,4-tetrakis(hydroxymethy)cyclohexane, and/or dipentaerythritol.

The process for directly measuring color of copolyester particles comprises b) obtaining a composite fluid comprising a transparent liquid and nanoparticles. In some aspects the transparent liquid comprises dimethylaminoethanol, ethylene glycol, ethanolamine, polyethylene glycol, glycerol, silicone oil, and/or polymethylphenyl-siloxane. In some aspects, the transparent liquid comprises polyethylene glycol, glycerol, silicone oil, and/or polymethylphenyl-siloxane. In some aspects, the transparent liquid comprises polyethylene glycol. In some aspects the polyethylene glycol has a molecular weight ranging from 50 to 1000, or from 100 to 800, or from 200 to 600.

In some aspects, the nanoparticles comprise zirconia. In some aspects, the nanoparticles consist of zirconia. In some aspects, the nanoparticles have an average diameter less than 10 nm, less than 15 nm, less than 20 nm, less than 30 nm, less than 50 nm, less than 75 nm, less than 100 nm, or less than 150 nm.

In some aspects, step b), obtaining the composite liquid comprises i) obtaining the transparent liquid; ii) obtaining the nanoparticles, wherein the nanoparticles are dispersed in a first volatile liquid; iii) mixing the transparent liquid and the nanoparticles to form a mixture; and applying heat to the mixture to remove the first volatile liquid and form the composite liquid.

The process for directly measuring color of copolyester particles comprises c) preparing a sample by combining a first fraction of the copolyester particles with the composite fluid. In some aspects, the preparing the sample comprises i) adding copolyester particles to the spectrophotometry instrument sample-holder; ii) adding the composite liquid to the sample-holder after step i); and iii) placing the sample in an oven for a period of time. The oven temperature and period of time are not particularly limited and are only needed to remove any unwanted volatile liquids and air bubbles from the sample. In some aspects, the oven temperature ranges from 40° C. to 80° C. In some aspects, the period of time ranges from 30 minutes to 48 hours, or from 30 minutes to 24 hours, or from 30 minutes to 12 hours.

In some aspects, for example, if the composite liquid has a high concentration of nanoparticles, the step c) preparing a sample further comprises, iv) before step ii), adding a second volatile liquid to the composite liquid. In some aspects, the second volatile liquid has a normal boiling point at least 5° C. lower, or at least 10° C. lower, or at least 15° C. lower than a normal boiling point of the first volatile liquid. This dissolution step can ensure that the composite liquid gets well distributed among the copolyester particles while being removed from the sample before measurements are made, thus not impacting the refractive index of the composite liquid in the sample as tested.

The form of the copolyester particles is not particularly limited. In some aspects, the copolyester particles are selected from the group consisting of pellets, powders, granules, and recycled scrap pieces.

The process for directly measuring color of copolyester particles comprises d) performing transmission spectrophotometry to determine a color of the sample. Performing transmission spectrophotometry on a sample to determine its color is well known to one skilled in the art of color measurement.

Listed below are non-limiting embodiments A1-A11.

A1. A process for directly measuring the color of polymer particles, the process comprising: a) obtaining polymer particles; b) obtaining a composite fluid comprising a transparent liquid and nanoparticles; c) preparing a sample by combining a first fraction of the polymer particles with the composite fluid; and d) performing transmission spectrophotometry to determine a color of the sample, wherein the polymer particles are transparent, wherein the transparent liquid is inert to the polymer particles; and wherein an absolute difference between the refractive index of the polymer particles and the refractive index of the composite fluid (ΔRI) is less than 0.02.

A2. The process of Embodiment A1, wherein a Euclidean distance (ΔE) between the sample and a plaque made from a second fraction of the polymer particles, based upon L*, a*, and b*, is less than 20, or less than 15, or less than 10.

A3. The process of any of Embodiments A1 or A2, wherein the ΔRI is less than 0.015, or less than 0.01, or less than 0.005.

A4. The process of any of Embodiments A1-A3, wherein the polymer particles comprise acrylic (polymethylmethacrylate), polyester, copolyester, polycarbonate, polystyrene, butyrate (cellulose acetate butyrate), cylco olefin polymers, poly-l-lactic-acid (PLLA), polyurethane, polyurea, and/or polyethersulfone (PES); or wherein the polymer particles are selected from the group consisting of acrylic (polymethylmethacrylate), polyester, copolyester, polycarbonate, polystyrene, butyrate (cellulose acetate butyrate), cylco olefin polymers, poly-l-lactic-acid (PLLA), polyurethane, polyurea, and/or polyethersulfone (PES).

A5. The process of any of Embodiments A1-A4, wherein the transparent liquid comprises dimethylaminoethanol, ethylene glycol, ethanolamine, polyethylene glycol, glycerol, silicone oil, and/or polymethylphenyl-siloxane; or wherein the transparent liquid comprises polyethylene glycol, glycerol, silicone oil, and/or polymethylphenyl-siloxane; or wherein the transparent liquid comprises polyethylene glycol, and wherein the polyethylene glycol has a molecular weight ranging from 50 to 1000, or from 100 to 800, or from 200 to 600.

A6. The process of any of Embodiments A1-A5, wherein the nanoparticles comprise zirconia and/or titania; or wherein the nanoparticles comprise zirconia.

A7. The process of any of Embodiments A1-A6, wherein the nanoparticles have an average diameter less than 10 nm, less than 15 nm, less than 20 nm, less than 30 nm, less than 50 nm, less than 75 nm, less than 100 nm, or less than 150 nm.

A8. The process of any of Embodiments A1-A7, wherein the step b), the obtaining the composite liquid comprises: i) obtaining the transparent liquid; ii) obtaining the nanoparticles, wherein the nanoparticles are dispersed in a first volatile liquid; iii) mixing the transparent liquid and the nanoparticles to form a mixture; and iv) applying heat to the mixture to remove the first volatile liquid and form the composite liquid.

A9. The process of any of Embodiments A1-A8, wherein the step c), the preparing the sample, comprises: i) adding the polymer particles to the spectrophotometry instrument sample-holder; ii) adding the composite liquid to the sample-holder after step i); and iii) placing the sample-holder in an oven for a period of time, wherein an oven temperature ranges from 40° C. to 80° C. and the period of time ranges from 30 minutes to 48 hours, or from 30 minutes to 24 hours, or from 30 minutes to 12 hours.

A10. The process of Embodiment A9, further comprising: iv) before step ii), adding a second volatile liquid to the composite liquid, wherein the second volatile has a normal boiling point at least 5° C. lower, or at least 10° C. lower, or at least 15° C. lower than a normal boiling point of the first volatile liquid

A11. The process of any of Embodiments A1-A10, wherein the polymer particles comprise pellets; or wherein the polymer particles are selected from the group consisting of pellets, powders, granules, and recycled scrap pieces; or wherein the polymer particles consist of pellets.

Listed below are additional non-limiting embodiments B1-B14.

B1. A process for directly measuring the color of copolyester particles, the process comprising: a) obtaining copolyester particles; b) obtaining a composite fluid comprising a transparent liquid and zirconia and/or titania nanoparticles; c) preparing a sample by combining a first fraction of the copolyester particles with the composite fluid; and d) performing transmission spectrophotometry to determine a color of the sample, wherein the transparent liquid is inert to the copolyester particles, and wherein the absolute difference between the refractive index of the copolyester particles and the refractive index of the composite fluid (ΔRI) is less than 0.02.

B2. The process of Embodiment B1, wherein a Euclidean distance (ΔE) between the sample and a plaque made from a second fraction of the copolyester particles, based upon L*, a*, and b*, is less than 20 or less than 15, or less than 10.

B3. The process of any of Embodiments B1 or B2, wherein the ART is less than 0.015, or less than 0.01, or less than 0.005.

B4. The process of any of Embodiments B1-B3, wherein the copolyester particles comprise units of an acid component and units of a glycol component; wherein the copolyester includes 100 mole % of the acid component and 100 mole % of the glycol component; wherein the units of the acid component comprise units derived from terephthalic acid and units derived from the group consisting of isophthalic acid, 1,3-cyclohexanedicarboxylic acid, 1,4-cyclohexanedicarboxylic acid, a naphthalenedicarboxylic acid, stilbenedicarboxylic acid, sebacic acid, dimethylmalonic acid, and/or succinic acid; and wherein the units of the glycol component comprise units derived from the group consisting of ethylene glycol, cyclohexanedimethanol, 1,2-propanediol, 1,3-propanediol, neopentyl glycol, 1,4-butanediol, 1,5-pentanediol, 1,6-hexanediol, p-xylene glycol, polyethylene glycols, polytetramethylene glycols, and/or 2,2,4,4-tetramethyl-1,3-cyclobutanediol.

B5. The process of Embodiment B4, wherein the units of the acid component comprise units derived from terephthalic acid and units derived from the group consisting of isophthalic acid, 1,3-cyclohexanedicarboxylic acid, and/or 1,4-cyclohexanedicarboxylic acid; and wherein the glycol units comprise units derived from the group consisting of ethylene glycol, cyclohexanedimethanol, neopentyl glycol, 1,4-butanediol, 1,5-pentanediol, 1,6-hexanediol, and/or 2,2,4,4-tetramethyl-1,3-cyclobutanediol.

B6. The process of any of Embodiments B4 or B5, wherein the acid component further comprises 0.1 mole % to 1.5 mole % of a branching agent selected from the group consisting of trimellitic anhydride, trimellitic acid, pyromellitic dianhydride, trimesic acid, hemimellitic acid, glycerol, trimethylolpropane, pentaerythritol, 1,2,4-butanetriol, 1,2,6-hexanetriol, sorbitol, 1,1,4,4-tetrakis(hydroxymethy)cyclohexane, and/or dipentaerythritol.

B7. The process of any of Embodiments B1-B6, wherein the transparent liquid comprises dimethylaminoethanol, ethylene glycol, ethanolamine, polyethylene glycol, glycerol, silicone oil, and/or polymethylphenyl-siloxane; or wherein the transparent liquid comprises polyethylene glycol, glycerol, silicone oil, and/or polymethylphenyl-siloxane/

B8. The process of any of Embodiments B1-B7, wherein the transparent liquid comprises polyethylene glycol, and wherein the polyethylene glycol has a molecular weight ranging from 50 to 1000, or from 100 to 800, or from 200 to 600.

B9. The process of any of Embodiments B1-B8, wherein the nanoparticles comprise zirconia; or wherein the nanoparticles consist of zirconia.

B10. The process of any of Embodiments B1-B9, wherein the nanoparticles have an average diameter less than 10 nm, less than 15 nm, less than 20 nm, less than 30 nm, less than 50 nm, less than 75 nm, less than 100 nm, or less than 150 nm.

B11. The process of any of Embodiments B1-B10, wherein the step b), the obtaining the composite liquid comprises: i) obtaining the transparent liquid; ii) obtaining the nanoparticles, wherein the nanoparticles are dispersed in a first volatile liquid; iii) mixing the transparent liquid and the nanoparticles to form a mixture; and iv) applying heat to the mixture to remove the first volatile liquid and form the composite liquid.

B12. The process of any of Embodiments B1-B11, wherein the step c), the preparing the sample comprises: i) adding the copolyester particles to the spectrophotometry instrument sample-holder; ii) adding the composite liquid to the sample-holder after step i); and iii) placing the sample-holder in an oven for a period of time, wherein the oven temperature ranges from 40° C. to 80° C. and the period of time ranges from 30 minutes to 48 hours, or from 30 minutes to 24 hours, or from 30 minutes to 12 hours.

B13. The process of Embodiment B12, further comprising iv) before step ii), adding a second volatile liquid to the composite liquid, wherein the second volatile liquid has a normal boiling point at least 5° C. lower, or at least 10° C. lower, or at least 15° C. lower than a normal boiling point of the first volatile liquid.

B14. The process of any of Embodiments B1-B13, wherein the copolyester particles comprise pellets; or wherein the copolyester particles are selected from the group consisting of pellets, powders, granules, and recycled scrap pieces; or wherein the copolyester particles consist of pellets.

### EXAMPLES

All copolyester pellet and plaque samples, EASTMAN TRITAN Copolyester Tx2000, EASTMAN SPECTAR Copolyester 14471, EASTAR Copolyester BR001, and EASTAR Copolyester DN004 Natural, were supplied by Eastman Chemical Company (Kingsport, Tenn.). The copolyesters are referred to as X1, X2, X3, and X4, respectively throughout the examples. Zirconia oxide nanoparticles (10 nm diameter PCPB-2-50-ETA, Pixelligent, 50 wt. % in ethyl acetate) and polyethylene glycol (molecular weight 400, Thermo-Fisher Scientific) were used to prepare high refractive index liquids. Transmission spectrophotometry was performed using 1.5 mL semi-microcuvettes (1 cm path length, CMBH) and a Jasco V-550 UV-Vis Spectrophotometer.

### Example 1—Direct Spectrophotometry

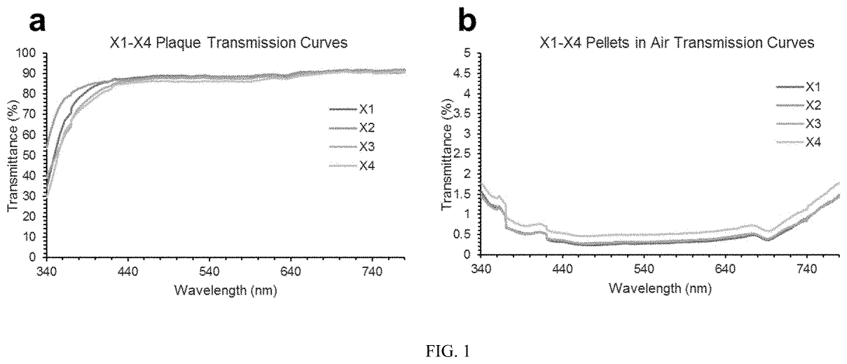

The transmission spectra of X1-X4 copolyester plaque (FIG. 1a) and pellet (FIG. 1B) samples were first analyzed to illustrate the fundamental problem with the color characterization of pellet samples. The high transmission values of the polymer plaque samples indicate the optical clarity of the plaques and the near-zero transmittance values for the chemically identical polymer pellets are related to the surface scattering effects by the copolyester pellets. As making plaques is costly and time consuming, we set out to find a refractive index-matching medium that would mitigate the scattering and surface effects.

### Example 2—Measurement of Refractive Indices of Copolyester Plaques

Refractive indices of all solid and liquid samples were measured using a 2WAJ Abbe Digital LCD monocular refractometer. The refractive indices of X1, X2, X3, and X4 plaques were measured. Results are given in Table 1 below. Sample spectra were obtained in transmission mode from 360-780 nm with band width of 1 nm and a scanning speed of 1000 nm/min. Before analysis, the spectrophotometer was first baseline corrected with an empty reference compartment and a micro-cuvette containing pure PEG400. Following this, sample spectra were obtained with copolyester pellets in the PEG-Zirconia liquids in a cuvette in the sample cell while keeping the reference compartment empty.

TABLE 1
Refractive Indices of Copolyesters

| Polymer ID | Refractive Index |
|---|---|
| X1 | 1.55 |
| X2 | 1.57 |
| X3 | 1.58 |
| X4 | 1.58 |

### Example 3—Refractive Index Matching Using Pure Liquids

Pellets of copolyesters X1-X4 were placed in a clear container and acetone was added to the container such that the pellets were submerged. The pellets were visually checked at 10 minutes and at 2 days for signs of any changes. The pellets were found to dissolve in the acetone. The experiment was repeated for other liquids. The liquid, supplier, refractive index, and compatibility are noted in Table 2. The highest pure liquid refractive index that did not dissolve the copolyester pellets was polymethylphenelsiloxane with a refractive index of 1.535 which is below the range of refractive indices for X1-X4, 1.55-1.58, as shown in Table 1 above.

TABLE 2
Refractive Index Matching Using Pure Liquids

| | | | Compat- | |
|---|---|---|---|---|
| | | Refrac- | ibility with | |
| | | tive | copoly- | |
| Liquid | Supplier | Index | esters | Notes |
| Acetone | Fisher-Scientific | 1.36 | No | Dissolves |
| Dimethylaminoethanol | Sigma-Aldrich | 1.43 | Yes | |
| Ethylene Glycol | Alfa Aesar | 1.43 | Yes | |
| Ethanolamine | Sigma-Aldrich | 1.434 | Yes | |
| AR 20 Silicone Oil | Sigma-Aldrich | 1.44 | Yes | |
| Chloroform | Sigma-Aldrich | 1.445 | No | Dissolves |
| 95% Glycerol, 5% | Fisher-Scientific | 1.465 | Yes | |
| H2O | | | | |
| PEG400 | Alfa Aesar | 1.467 | Yes | |
| Glycerol | Fisher-Scientific | 1.474 | Yes | |
| AP 1000 Silicone Oil | Sigma-Aldrich | 1.51 | Yes | |
| Polymethylphenyl- | Sigma-Aldrich | 1.535 | Yes | |
| siloxane | | | | |
| Cassia Oil | N/A | 1.59 | No | Dissolves |
| 1-bromonaphthalene | Sigma-Aldrich | 1.657 | No | Dissolves |
| Diiodomethane | Sigma-Aldrich | 1.74 | No | Dissolves & |
| | | | | yellows |

### Example 4—Preparation of PEG400 ZrO₂ Composite Liquids

To produce a range of high refractive index PEG400-ZrO₂ composite liquids for pellet color analysis, the ZrO₂ in ethyl acetate nanoparticle suspension (50 wt. % ZrO₂) was carefully added to a known mass of PEG400 and the volatile ethyl acetate was boiled from the mixture at 80° C. for 24 hours to remove ethyl acetate. A range of PEG400-ZrO₂ fluids with refractive indices in the range of 1.51-1.61 were produced. For all samples PZ# indicated the PEG-ZrO₂ liquid with a final ZrO₂ wt. % of #, e.g., PZ45 is a PEG400-ZrO₂ composite fluid containing a final ZrO₂ concentration of 45 wt. %.

### Example 5—Color Measurements of Copolyester Pellets in Composite Liquids

To prepare samples for analysis, pellets were first added to the micro-cuvettes insuring maximal pellet packing. The high refractive index liquids were subsequently added to the cuvettes and placed in an oven at 60° C. for 48 hours before analysis by spectrophotometry. The samples were placed in the oven prior to analysis to remove any remaining unwanted volatile liquid from the mixture and to remove air bubbles trapped within the cell. For composite liquids containing over 53 wt. % ZrO₂ in PEG400, methanol was first added to the PEG400-ZrO₂ liquid to dilute the liquid and reduce the mixture's viscosity and magnetically stirred for 30 minutes. Once homogenously dissolved in methanol, this mixture was added to the pellets in the micro-cuvette and the methanol was boiled off in an oven at 60° C. for 48 hours.

The X1-X4 copolyester pellet samples were immersed in the varying ratio PEG400-ZrO₂ composite liquids and analyzed by transmission spectrophotometry. To normalize the refractive index differences between the PEG400-ZrO₂ liquids and the polymer pellets of varying refractive index, the A Refractive Index for each sample was calculated. The CIELAB L*, a*, and b* values were determined for each sample. The L* values of the X1-X4 pellets in the high refractive index liquids all show maxima near L*=90 when the refractive index of the liquid is closely matched to that of the polymer sample (i.e., when ΔRI is near zero). The a* and b* values show similar trends with both reaching values near zero for all copolyester samples X1-X4.

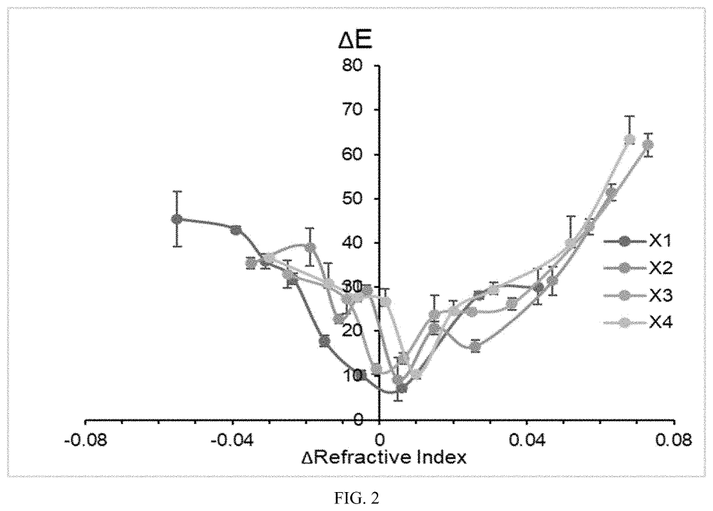

The L*, a*, and b* values of the X1-X4 pellets in high refractive index liquids were converted to ΔE values with the reference L*, a* and b* values being those of their respective X1-X4 plaques measured using the same instrument. The ΔRI and ΔE values are shown in Table 3 and plotted in FIG. 2. The ΔE values for all copolyester pellet samples reach a minimum near or below a value of ΔE=10 for all samples.

TABLE 3
Calculated differences in refractive indices of the composite fluid
and copolyester and the Euclidean distance between the color of
the sample and the color of the corresponding copolyester plaque.

| X1 | | X2 | | X3 | | X4 | |
|---|---|---|---|---|---|---|---|
| ΔRI | ΔE | ΔRI | ΔE | ΔRI | ΔE | ΔRI | ΔE |
| 0.043 | 30.076 | 0.063 | 51.401 | 0.073 | 62.127 | 0.068 | 63.468 |
| 0.027 | 28.194 | 0.047 | 31.480 | 0.057 | 43.685 | 0.052 | 39.898 |
| 0.006 | 7.112 | 0.026 | 16.604 | 0.036 | 26.212 | 0.031 | 29.479 |
| −0.005 | 10.121 | 0.015 | 20.659 | 0.025 | 24.486 | 0.020 | 24.712 |
| −0.015 | 17.872 | 0.005 | 9.157 | 0.015 | 23.762 | 0.010 | 10.310 |
| −0.0235 | 31.938 | −0.035 | 29.270 | 0.0065 | 13.899 | 0.0015 | 26.652 |
| −0.031 | 35.857 | −0.011 | 22.776 | −0.001 | 11.496 | −0.006 | 27.788 |
| −0.039 | 42.975 | −0.019 | 39.043 | −0.009 | 27.346 | −0.014 | 30.889 |
| −0.055 | 45.409 | −0.035 | 35.443 | −0.025 | 32.993 | −0.030 | 36.589 |

### Example 6—Comparisons of Color Measurements for X1

Color of X1 plaque and X1 pellets in air were measured by direct spectrophotometry, Example 1. Color of X1 pellets in PZ45 were also measure by spectrophotometry, Example 5. Color of X1 pellets in air was also measured using reflectance. The ΔE values with the reference L*, a* and b* values of the X1 plaque color are given in Table 4. The process of the present invention shows a marked improvement compared to pellets analyzed by typical reflectance and transmission spectrophotometry of copolyester pellets in air.

TABLE 4
ΔE values for X1 color measured by different techniques

| Form of X1 | Measurement Technique | ΔE |
|---|---|---|
| Plaque | Spectrophotometry | 0 |
| Pellets in PZ45 | Spectrophotometry | 7.23 |
| Pellets in air | Spectrophotometry | 92.9 |
| Pellets in air | Reflectance | 27.8 |

### Example 7—Color Measurements of Copolyester X1 Pellets from 4 Manufacturing Batches

The same analysis that was performed on the X1-X4 pellets in PZ liquids, Example 5, was then performed for the different batches of X1 pellets and the L*, a*, and b* values of the different samples in the range of high refractive index liquids were measured. The reflective index of each batch was assumed to be the same value as the one measured on the plaque in Example 2, 1.55.

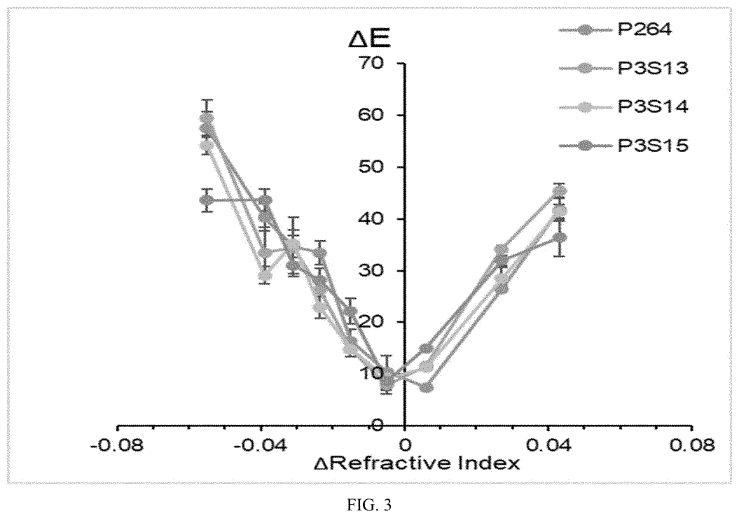

The L*, a*, and b* values were converted to the ΔE color distance values, given in Table 5 and FIG. 3. A deep minimum with all pellet samples reaching ΔE values below 10 can be seen with a close refractive index match between the pellet and composite liquid. The closely aligned trends seen in these curves indicate that the refractive index matching method could be applied as a method for anomaly detection with repeated manufactured batches of the same copolyester and could be used as a high throughput method to measure polymer pellet refractive index and color without necessitating the time expenditure of plaque injection molding.

TABLE 5
Calculated differences in refractive indices of the composite
fluid and copolyester and the Euclidean distance between
the color of the sample of different batches of X1
compared to X1 plaque.

| | X1 | P264 | P3S13 | P3S14 | P3S15 |
|---|---|---|---|---|---|
| ΔRI | ΔE | ΔE | ΔE | ΔE | ΔE |
| 0.043 | 30.076 | 41.780 | 45.444 | 41.446 | 36.407 |
| 0.027 | 28.194 | 26.430 | 34.185 | 28.455 | 31.999 |
| 0.006 | 7.112 | 7.469 | 11.572 | 11.207 | 15.061 |
| −0.005 | 10.121 | 10.438 | 7.911 | 9.305 | 8.567 |
| −0.015 | 17.872 | 16.423 | 14.856 | 14.856 | 22.165 |
| −0.0235 | 31.938 | 33.454 | 26.166 | 22.846 | 28.116 |
| −0.031 | 35.857 | 34.549 | 34.467 | 35.286 | 31.029 |
| −0.039 | 42.975 | 40.288 | 33.503 | 29.105 | 43.661 |
| −0.055 | 45.409 | 57.512 | 59.548 | 54.136 | 43.624 |

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A process for directly measuring the color of polymer particles, the process comprising:
a) obtaining polymer particles;
b) obtaining a composite fluid comprising a transparent liquid and nanoparticles;
c) preparing a sample by combining a first fraction of the polymer particles with the composite fluid; and
d) performing transmission spectrophotometry to determine a color of the sample,
wherein the polymer particles are transparent,
wherein the transparent liquid is inert to the polymer particles; and
wherein an absolute difference between the refractive index of the polymer particles and the refractive index of the composite fluid (ΔRI) is less than 0.02.

2. The process of claim 1, wherein a Euclidean distance (ΔE) between the sample and a plaque made from a second fraction of the polymer particles, based upon L*, a*, and b*, is less than 20, and wherein the ΔRI is less than 0.015.

3. The process of claim 1, wherein the polymer particles comprise acrylic (polymethylmethacrylate), polyester, copolyester, polycarbonate, polystyrene, butyrate (cellulose acetate butyrate), cylco olefin polymers, poly-l-lactic-acid (PLLA), polyurethane, polyurea, and/or polyethersulfone (PES).

4. The process of claim 1, wherein the transparent liquid comprises dimethylaminoethanol, ethylene glycol, ethanolamine, polyethylene glycol, glycerol, silicone oil, and/or polymethylphenyl-siloxane.

5. The process of claim 1, wherein the nanoparticles comprise zirconia and/or titania, and wherein the nanoparticles have an average diameter less than 150 nm.

6. The process of claim 1, wherein the step b), the obtaining the composite liquid comprises:
i) obtaining the transparent liquid;
ii) obtaining the nanoparticles, wherein the nanoparticles are dispersed in a first volatile liquid;
iii) mixing the transparent liquid and the nanoparticles to form a mixture; and
iv) applying heat to the mixture to remove the first volatile liquid and form the composite liquid.

7. The process of claim 1, wherein the step c), the preparing the sample comprises:
i) adding the polymer particles to a spectrophotometry instrument sample-holder;
ii) adding the composite liquid to the sample-holder after step i); and
iii) placing the sample-holder in an oven for a period of time,
wherein an oven temperature ranges from 40° C. to 80° C. and the period of time ranges from 30 minutes to 48 hours,
and optionally further comprising:
iv) before step ii), adding a second volatile liquid to the composite liquid, wherein the second volatile has a normal boiling point at least 5° C. lower than a normal boiling point of the first volatile liquid.

8. The process of claim 1, wherein the polymer particles are selected from the group consisting of pellets, powders, granules, and recycled scrap pieces.

9. A process for directly measuring the color of copolyester particles, the process comprising:
a) obtaining copolyester particles;
b) obtaining a composite fluid comprising a transparent liquid and nanoparticles;
c) preparing a sample by combining a first fraction of the copolyester particles with the composite fluid; and
d) performing transmission spectrophotometry to determine a color of the sample,
wherein the transparent liquid is inert to the copolyester particles,
wherein the nanoparticles comprise zirconia and/or titania, and
wherein the absolute difference between the refractive index of the copolyester particles and the refractive index of the composite fluid (ΔRI) is less than 0.02.

10. The process of claim 9, wherein a Euclidean distance (ΔE) between the sample and a plaque made from a second fraction of the copolyester particles, based upon L*, a*, and b*, is less than 20, and wherein the ΔRI is less than 0.015.

11. The process of claim 9, wherein the copolyester particles comprise units of an acid component and units of a glycol component; wherein the copolyester includes 100 mole % of the acid component and 100 mole % of the glycol component; wherein the units of the acid component comprise units derived from terephthalic acid and units derived from the group consisting of isophthalic acid, 1,3-cyclohexanedicarboxylic acid, 1,4-cyclohexanedicarboxylic acid, a naphthalenedicarboxylic acid, stilbenedicarboxylic acid, sebacic acid, dimethylmalonic acid, and/or succinic acid; and
wherein the units of the glycol component comprise units derived from the group consisting of ethylene glycol, cyclohexanedimethanol, 1,2-propanediol, 1,3-propanediol, neopentyl glycol, 1,4-butanediol, 1,5-pentanediol, 1,6-hexanediol, p-xylene glycol, polyethylene glycols, polytetramethylene glycols, and/or 2,2,4,4-tetramethyl-1,3-cyclobutanediol.

12. The process of claim 11, wherein the units of the acid component comprise units derived from terephthalic acid and units derived from the group consisting of isophthalic acid, 1,3-cyclohexanedicarboxylic acid, and/or 1,4-cyclohexanedicarboxylic acid; and
wherein the glycol units comprise units derived from the group consisting of ethylene glycol, cyclohexanedimethanol, neopentyl glycol, 1,4-butanediol, 1,5-pentanediol, 1,6-hexanediol, and/or 2,2,4,4-tetramethyl-1,3-cyclobutanediol.

13. The process of claim 11, wherein the acid component further comprises 0.1 mole % to 1.5 mole % of a branching agent selected from the group consisting of trimellitic anhydride, trimellitic acid, pyromellitic dianhydride, trimesic acid, hemimellitic acid, glycerol, trimethylolpropane, pentaerythritol, 1,2,4-butanetriol, 1,2,6-hexanetriol, sorbitol, 1,1,4,4-tetrakis(hydroxymethy)cyclohexane, and/or dipentaerythritol.

14. The process of claim 9, wherein the transparent liquid comprises dimethylaminoethanol, ethylene glycol, ethanolamine, polyethylene glycol, glycerol, silicone oil, and/or polymethylphenyl-siloxane.

15. The process of claim 9, wherein the transparent liquid comprises polyethylene glycol, and wherein the polyethylene glycol has a molecular weight ranging from 50 to 1000.

16. The process of claim 9, wherein the nanoparticles comprise zirconia, and wherein the nanoparticles have an average diameter less than 150 nm.

17. The process of claim 9, wherein the step b), the obtaining the composite liquid comprises:
i) obtaining the transparent liquid;
ii) obtaining the nanoparticles, wherein the nanoparticles are dispersed in a first volatile liquid;
iii) mixing the transparent liquid and the nanoparticles to form a mixture; and
iv) applying heat to the mixture to remove the first volatile liquid and form the composite liquid.

18. The process of claim 9, wherein the step c), the preparing the sample comprises:
i) adding the copolyester particles to a spectrophotometry instrument sample-holder;
ii) adding the composite liquid to the sample-holder after step i); and
iii) placing the sample-holder in an oven for a period of time,
wherein an oven temperature ranges from 40° C. to 80° C. and the period of time ranges from 30 minutes to 48 hours.

19. The process of claim 18, further comprising:
iv) before step ii), adding a second volatile liquid to the composite liquid,
wherein the second volatile liquid has a normal boiling point at least 5° C. lower than a normal boiling point of the first volatile liquid.

20. The process of claim 9, wherein the copolyester particles are selected from the group consisting of pellets, powders, granules, and recycled scrap pieces.
